(19) United States
(12) Patent Application Publication
(10) Pub. No.: US 2026/0259702 A1
(43) Pub. Date: Sep. 3, 2026

(54) LARGE LANGUAGE MODELS (LLMS)-BASED REGULATORY INFORMATION TRANSFORMATION

(71) Applicant: Purdue Research Foundation, West Lafayette, IN (US)

(72) Inventors: Jiansong Zhang, West Lafayette, IN (US); Fan Yang, West Lafayette, IN (US)

(21) Appl. No.: 19/551,215

(22) Filed: Feb. 26, 2026

Related U.S. Application Data
(60) Provisional application No. 63/765,345, filed on Feb. 28, 2025.

(51) Int. Cl. G06F 8/30

(52) U.S. Cl. CPC G06F 8/30

(57) ABSTRACT

A system for generating and distributing building code compliance scripts includes a processor, a communications system configured to transmit and receive information from users and building code resources via a communication network, and a memory storing software instructions. The system receives an indication of a target building code for translation, determines a programming language with logic-based syntax for outputs of a building code translation model, obtains and preprocesses a copy of the target building code, and initializes the model to recognize the determined programming language. The system generates an initial programming script encoding compliance rules into logic statements, validates the script by comparing it to a predefined standard or performing functional equivalence checks, refines the script until achieving a threshold level of accuracy, and distributes the refined programming script to end-users.

### CROSS-REFERENCE TO RELATED APPLICATION(S)

This application claims priority to U.S. Provisional Application No. 63/765,345, filed on Feb. 28, 2025, the contents of which are hereby incorporated by reference in their entirety.

### STATEMENT REGARDING FEDERALLY SPONSORED RESEARCH

This invention was made with government support under 1827733 awarded by the National Science Foundation. The government has certain rights in the invention.

### BACKGROUND

The design and construction of buildings are governed by a variety of building codes, regulations, standards, and specifications, which vary by jurisdiction and are often highly specific to particular aspects of construction. Building codes may include national standards, such as the International Building Code (IBC), as well as state, county, and municipal codes tailored to local needs and conditions. In addition to these legal and regulatory requirements, industry standards set by organizations such as the American Society of Civil Engineers (ASCE), the National Fire Protection Association (NFPA), and the International Code Council (ICC) often play a role in determining compliance requirements. Moreover, many building codes incorporate references to manufacturer specifications and installation instructions, which may dictate precise methods for installing specific products, such as windows, roofing materials, insulation systems, or fire suppression equipment. Together, these overlapping and interdependent sources of guidance create a complex web of requirements that engineers, architects, and builders navigate to ensure their designs are compliant, safe, and structurally sound.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its purpose is to present some concepts of one or more aspects of the disclosure in a simplified form as a prelude to the more detailed description that is presented later.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a conceptual flowchart illustrating the flow of data, actions, and decisions involved in a method for generating a programming script in accordance with certain experiments and validation studies performed by the inventors.

FIG. 2 is a block diagram conceptually illustrating information and I/O exchange between users, a user interaction module, and an information conversion module, in accordance with certain experiments and validation studies performed by the inventors.

FIG. 3 is a flowchart illustrating an example process according to an embodiment hereof.

FIG. 4 is a flowchart illustrating an example process according to an embodiment hereof.

FIG. 5 is a block diagram depicting conceptual relationships between various users, resources, and components of embodiments according to the present disclosure.

FIG. 6 is a flowchart illustrating a general example procedure for experiments according to the present disclosure.

FIG. 7 is an example graphical user interface of an information conversion module according to the present disclosure.

FIG. 8 is an example chat interface of a conversion module according to the present disclosure.

FIG. 9 is an example input interface of an information conversion module according to the present disclosure.

FIG. 10 is an example crash report according to the present disclosure.

FIG. 11 is a graph depicting results of certain experiments and validation studies performed by the inventors.

FIG. 12 is a graph depicting results of certain experiments and validation studies performed by the inventors.

FIG. 13 is a graph depicting results of certain experiments and validation studies performed by the inventors.

FIG. 14 is a graph depicting results of certain experiments and validation studies performed by the inventors.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

The disclosure in this detailed description section will include discussion of frameworks and associated general concepts that may be applicable to some or all of the more specific implementations contemplated herein; a discussion of the inventors' experiments and examples/prototypes used for validation; and descriptions of various embodiments or ways of implementing the systems and methods described herein. Thus, the descriptions of specific embodiments/implementations/examples should be understood to be capable of incorporating the more general frameworks and concepts as well as features of other specific embodiments, and vice versa.

The design and construction of buildings are governed by a variety of building codes, regulations, standards, and specifications, which vary by jurisdiction and are often highly specific to particular aspects of construction. Together, these overlapping and interdependent sources of guidance create a complex web of requirements that engineers, architects, and builders navigate to ensure their designs are compliant, safe, and structurally sound.

Currently, building code compliance software is typically developed and maintained through manual processes, requiring significant effort and expertise to create and update. Compliance scripts and logic may be manually written by developers who translate natural language building codes into machine-readable formats. When building codes, regulations, or standards are amended or updated, developers may manually review the changes, determine their impact on existing compliance scripts, and implement corresponding updates. This process is time-consuming, error-prone, and often lacks scalability, particularly for organizations that need to address compliance across multiple jurisdictions. Additionally, software users typically do not receive real-time updates when changes occur; instead, updates may be requested or implemented manually, leading to delays and increasing the risk of non-compliance.

While advancements in artificial intelligence (AI) have introduced new possibilities for automating aspects of compliance software, relying on untrained or unverified AI systems often fails to produce consistent, accurate, or reliable results. Building code compliance requires an exceptionally high degree of reliability and confidence, given the significant costs and risks associated with errors. Buildings are expensive to construct, and once built, correcting errors in compliance is often impractical or impossible. Untrained AI systems may misinterpret regulatory language, overlook critical details, or produce scripts that cannot be validated for accuracy, leading to uncertainty and potential liability. Therefore, there is a need for a reliable, automated process that can develop compliance scripts with accuracy, update them dynamically in response to regulatory changes, and ensure that the outputs are consistently validated and suitable for use in compliance-checking software. Such a process would address the limitations of current systems and provide confidence to developers, architects, engineers, and builders navigating complex compliance requirements.

Described herein are systems and methods that leverage prompt engineering and other features for full automation of building code information transformation. This framework includes: a front-end, executable file-based user interaction (UI) module for reading building code requirements, user instructions, and saving the generated programming script, and a back-end information conversion (IC) module for executing user instructions, information conversion and processing. Prompt engineering involves crafting specific input prompts to guide the model's output, tailoring the responses to accurately reflect the complex and nuanced language of building codes. This approach allows the model to effectively interpret and translate building regulations into machine-readable formats.

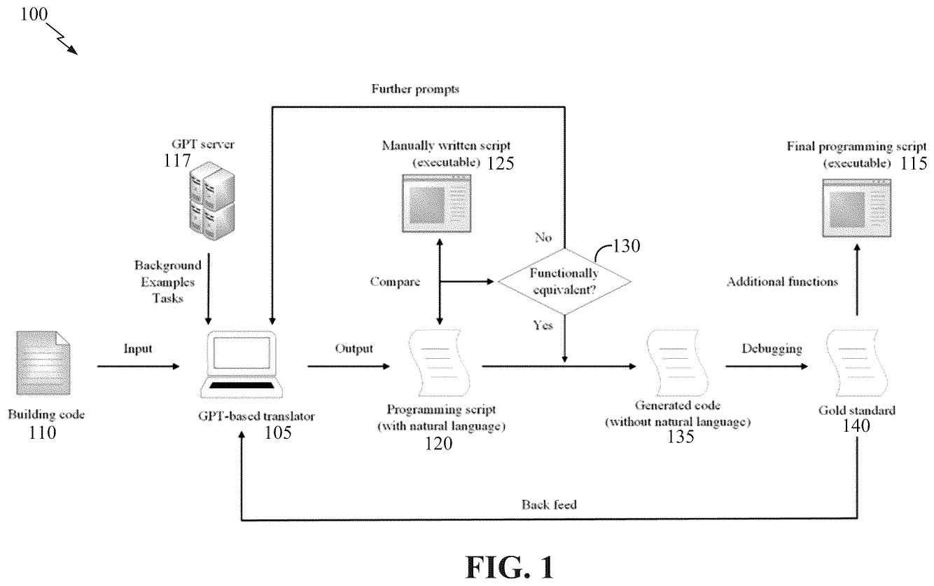

FIG. 1 illustrates a conceptual flowchart 100 illustrating a flow of data, actions, and decisions involved in a method for generating a programming script in accordance with certain experiments and validation. In some examples, the systems and methods include the creation of a generative pre-trained transformer (GPT)-based translator 105 to interpret building code requirements 110 and translate them into the target logic programming language as a final programming script 115. To configure this translator 105, the translator 105 is accessed through an application programming interface (API) and provided with information encompassing the concepts and grammatical rules of the intended programming language, alongside examples of inputs (building code requirements) and their corresponding outputs (logic programming code). This information, examples, and outputs are illustrated being provided by GPT server 117 in FIG. 1. The logic programming code generated is designed to encapsulate basic concepts of the building code within logic facts and articulate requirements of the code through logic rules.

Following the establishment of the translator 105, new building code requirements are translated based on specific task descriptions input into the system. The initial output from this translation process may be termed as programming script together with natural language 120, characterized by its inclusion of explanations and descriptions alongside the logic programming code. Concurrently, these new building code requirements undergo a manual analysis and translation into the target logic programming language, referred to as the manually written script 125, as illustrated in FIG. 1. The effectiveness of the translator 105 is evaluated by comparing its generated logic programming code against manually translated code (block 130) to determine their functional equivalence. Should discrepancies arise (the “No” branch), additional prompts may be used to refine the output until equivalence is reached. Upon achieving this milestone (the “Yes” branch), the programming script, initially rich in natural language explanations and descriptions, is meticulously processed to remove the natural language (generated code 135) extract a clean code version, designated as the gold standard 140. This version is recognized as the benchmark for accuracy and effectiveness, representing the building code requirements. To further enhance its utility, the gold standard 140 is augmented with specific built-in functions that facilitate compliance checking, thereby producing the final programming script 115 ready for execution on the logic programming language platform. Additionally, the gold standard 140 is recycled back into the training regime of the translator 105, serving as a component for the continuous improvement of its translation capabilities for future tasks.

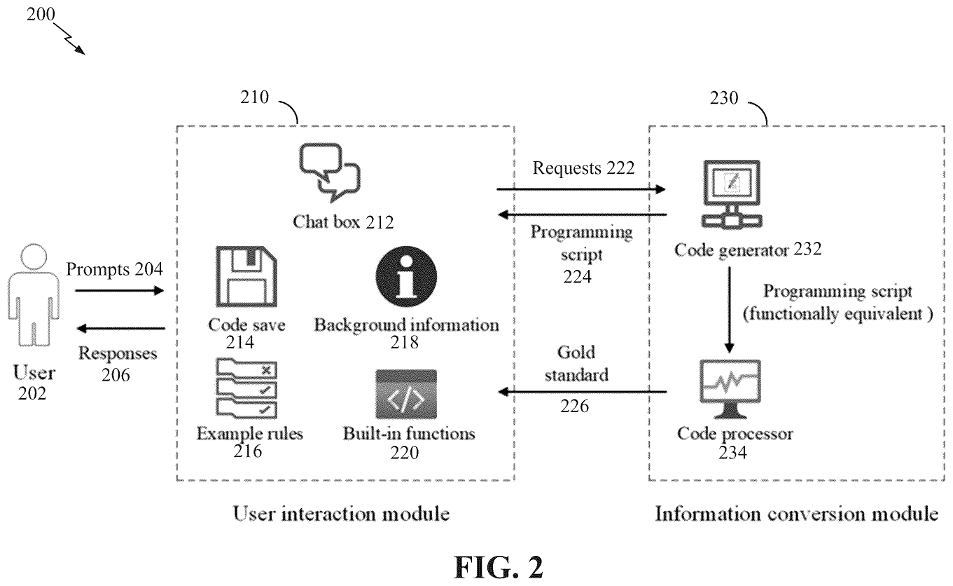

The logical workflow of the proposed framework is encapsulated within an executable file 200 incorporating a translator, with FIG. 2 illustrating a user's interactions with its two modules: user interaction module 210 and information conversion module 230. This framework can allow users 202 to input requests and prompts 204 to the translator, from which they also receive responses 206. In some examples, the user interaction module 210 features a chat box 212 for direct communication, a code save feature 214 for archiving the final programming script, an example rules function 216 for storing learning examples and gold standards, alongside background information 218 and built-in functions 220. Requests 222 from users 202 are relayed by the user interaction module 210 to a code generator 232. The code generator 232 may be an example of the translator 105 described with respect to FIG. 1. The code generator 232 assesses the requests 222, producing a corresponding programming script 224 that is then returned to the user interaction module 210 for a comparative verification against a manually written script. Upon achieving functional equivalence with the manually written script, the programming script 224 is forwarded to a code processor unit 234 to create the gold standard 226 (e.g., as described with respect to the gold standard 140 of FIG. 1). This standard 226 is then circulated back to the user interaction module 210, where it is preserved or stored as example rules 216. Subsequent to the formulation of the gold standard 226, users 202 can employ the code save feature 214 to refine it into an executable programming script, which can be stored locally on a computer.

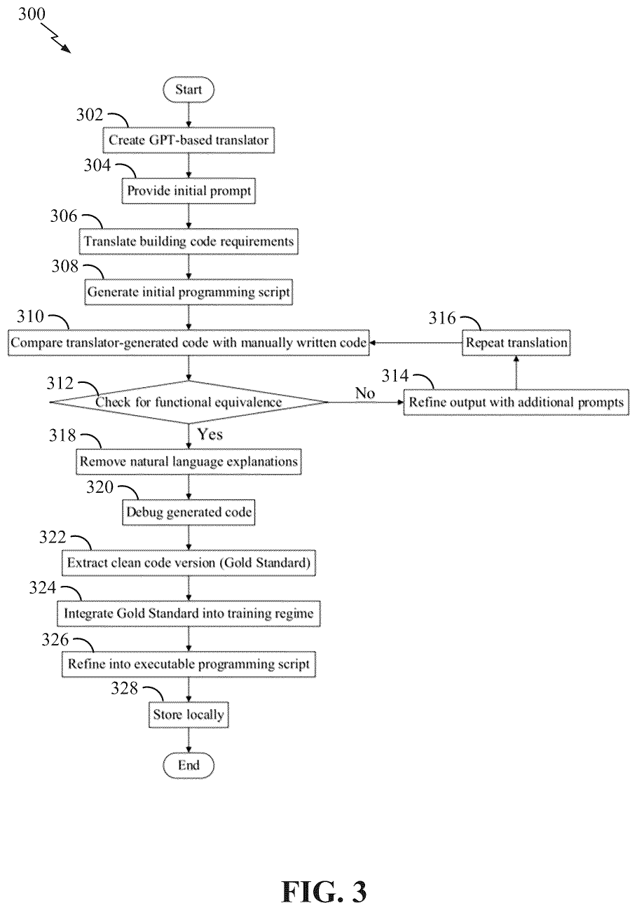

A unified modeling language (UML) diagram of the process flow 300 is presented in FIG. 3. The workflow initiates with the creation of a GPT-based translator at block 302. This translator is configured by providing it with foundational information, encompassing concepts, grammatical rules, and examples at block 304. Following the configuration, the translator undertakes the task of translating building code requirements into the target logic programming language, generating an initial programming script that includes logic facts and rules representing the building code requirements at block 306. To ensure the accuracy of the generated script, a comparison is made with a manually written version of the code at block 308. A decision point in the process involves checking for functional equivalence between the generated code and the manually written code at block 310. If discrepancies are identified, the output undergoes refinement through additional prompts at block 312, and the translation process is repeated at block 314. This iterative refinement continues until functional equivalence is achieved. Once the generated code is verified as functionally equivalent to the manually written code at block 316, the process advances to removing natural language explanations from the code to create a clean version at block 318. Subsequently, the generated code is debugged to ensure it is free from errors at block 320, resulting in the extraction of a clean code version referred to as the “gold standard” at block 322. This “gold standard” serves as a benchmark for accuracy and effectiveness. To enhance future translation tasks, the “gold standard” is integrated into the translator's training regime at block 324. The clean code version is further refined into an executable programming script at block 326, which is then stored locally for future use at block 328. The diagram concludes with the final storage of the executable programming script.

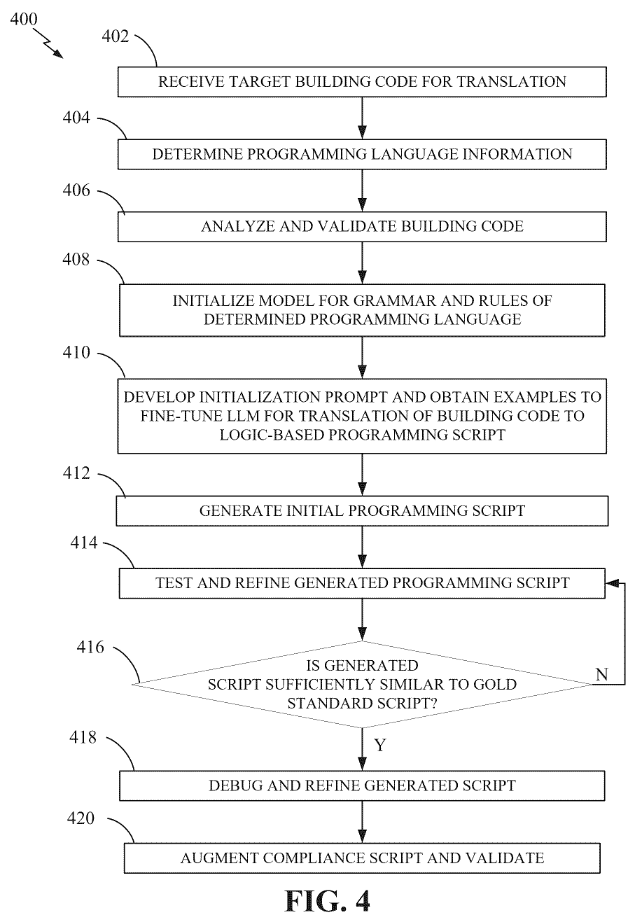

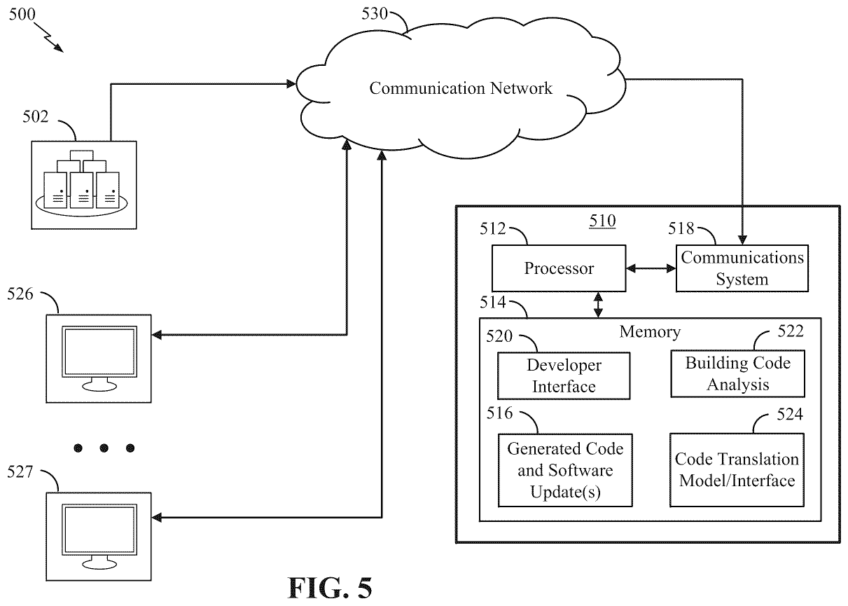

In some examples, the automated building code translation model may fully automate the translation process while maintaining accuracy and consistency through rigorous comparison and refinement steps. The integration of user interaction modules, which facilitate input requests, chat communication, code saving, and the storage of examples and gold standards, enhances the framework's usability. FIG. 4 illustrates a process 400 for developing, refining, and/or employing an example of such an automated building code translation mode. Additionally, FIG. 5 illustrates an example computing device comprising and employing an example of such an automated building code translation model (code translation model/interface 524). These examples are described further below.

### Example Process for Automated Building Code Translation Model

Referring now to FIG. 4, a flow diagram is depicted which illustrates an example process 400 for developing, refining, and/or employing an automated building code translation model. At block 402, the process 400 may involve receiving an indication of a target building code for translation. Such information may be provided by a user or developer, or other individual or entity that wishes to initialize and develop an automated building code translation model. In other examples, information regarding a target building code may be predefined (e.g., one or more example building codes may have already been identified or obtained, for purposes of model initialization). A target building code may relate to a particular country, state, county, municipality, etc., or may be managed by industry organizations (e.g., the code is a ‘best practice,’ industry standard, etc. rather than a law or regulation), or may be determined by a local association such as a home owners' association, or may be a recorded covenant applicable to a given property. A target building code may also relate to a given discipline or trade involved in building, such as electrical, fire protection, structural, exterior appearance, etc. The target building code may be received as an electronic file including digital data encoding the target building code written in natural language (e.g., in English or another language). The indication may be an identifier or address of the electronic file, or may be the electronic file itself.

At block 404, the process may entail determining information relating to a programming language to be used for outputs of the model. Depending upon the nature, format, content, etc. of the target building code, various programming languages may be suitable. Accordingly, at block 404, the process may select a programming language into which to translate the target building code based on characteristics of target building code. The process may have defined rules or conditions that evaluate the characteristics and map to a particular programming language. In the inventors' research, it was determined that logic-based programming languages often provide a beneficial syntax given the goals and nature of building code compliance checking. For example, Prolog/Picat were found to be useful languages in that they balanced simplicity, clarity, and rule-defining properties while still being common languages and usable/understandable by human developers. Logic-based programming languages like these have a declarative nature, which allows the model to correlate what can be achieved (rules and relationships) rather than how to achieve specific goals or step-by-step algorithms for assessing rules/relationships. They allow for a clear representation of rules in a way that makes it easier to assess whether a given fact/data input follows the rule or not. Moreover, logic-based programming languages allow for greater transparency and ease of validating outputs, compared to more complex and “black box” approaches like natural language-processing neural networks.

Thus, in some examples of block 404, the system may evaluate one or more structural and semantic characteristics of the target building code to select an output programming language. These characteristics may include, for example, rule structure complexity, dependency relationship density, a level of need of transparency and auditability, and output integration requirements. For example, with respect to rules structure complexity, the system may analyze whether the building code primarily contains deterministic, declarative constraints (e.g., “door width shall be ≥32 inches”), multi-condition logical rules (e.g., “if occupant load >50 AND space is assembly use, THEN two exits required”), procedural or algorithmic computations (e.g., structural load combinations, iterative calculations), or probabilistic or performance-based criteria. When the building code primarily consists of conditional logic rules and relational constraints, a logic-based declarative language (e.g., Prolog or Picat) may be selected. When the code requires stepwise procedural computation or simulation-based evaluation, a procedural language (e.g., Python) may be selected. When the code relies heavily on structured schema validation (e.g., JSON/XML BIM schemas), a constraint or schema validation language may be selected.

With respect to dependency and relationship density, the system may analyze the building code to determine a degree of cross-referencing between sections, a presence of nested conditions, and a number of variable bindings and entity relationships. Codes with dense relational dependencies may favor declarative logic programming because such languages natively support: backtracking; pattern matching; rule chaining; and relational inference.

With respect to a level of need for transparency and auditability, the system may determine whether an intended use case emphasizes regulatory traceability, auditable compliance decisions, or clear rule-to-output mapping. When a high level need for transparency and auditability are present, the system may prioritize logic-based languages that provide explicit rule representation and deterministic reasoning paths. When explainability is less critical and predictive approximation is acceptable, other paradigms (e.g., statistical models) may be selected.

With respect to output integration requirements, the system may analyze a downstream integration environment such as, for example, integration with BIM/IFC data (favoring languages with strong data structure support), web-based compliance APIs (favoring REST-integrated languages), rule engine frameworks (favoring languages compatible with production rule systems).

These various characteristics may be considered and evaluated by the system using various techniques to ultimately select a programming language. In one example, the system may implement rule-based language selection logic such as:

```
If:
  Code sections contain primarily “shall” statements,
  Logical connectors (AND/OR/IF-THEN) exceed threshold frequency,
  Limited numerical iteration is required,
→ Select declarative logic language (e.g., Prolog/Picat).
If:
  Code requires iterative numerical computation,
  Performance-based evaluation formulas are dominant,
→ Select procedural language (e.g., Python).
If:
    Code is tightly coupled to structured data schemas,
→ Select constraint/schema-based validation language.
```

In other examples, other conditions may be applied or other rankings or scoring of the various analyzed characteristics may be used to select a programming language.

Accordingly, in some examples, the process may evaluate structural, syntactic, and semantic characteristics of the target building code, including rule density, conditional branching complexity, relational dependency frequency, numerical computation requirements, and intended auditability level. Based on predefined mapping criteria, the process may select a declarative logic-based programming language when the code primarily contains conditional constraints and relational rules, or alternatively select a procedural or constraint-validation language when the code requires algorithmic computation or schema validation. In some embodiments, thresholds of logical connector frequency, cross-referencing density, or computational formula presence may be used as decision metrics for language selection.

In other examples, the programming language may be determined by user request/settings or according to the nature of the building code compliance software into which the model may be incorporated. Accordingly, in some examples, the process may include receiving such user request or settings and selecting the programming language based on the language indicated in the user request or settings. Additionally, in some examples, the process may include receiving an identification of the building code compliance software into which the model may be incorporated, and selecting the programming language based on that identification (e.g., based on predefined mapping of software identifications to programming languages). Process 400 may also obtain information regarding the syntax and use of the programming language at block 404, for subsequent training and initialization of the model.

At block 406, the process 400 may include analyzing and validating the target building code, based on the information received at block 402. In some examples, block 404 and 406 may be combined or performed in alternate order. For example, where a user has indicated which building code can be the target building code at block 402, process 400 may include obtaining a copy of the current building code directly from a trusted source (such as a legal reporting service, government website, industry association portal, etc.). In other examples, the building code itself may have already been provided, obtained, or stored. Thus, at block 406, process 400 may proceed to analyze the code and determine if the obtained copy is complete, contains any potential errors, is in a format that can be confidently processed and provided to a model, is current, is actually the code that a user requested, is facially applicable to and corresponds to other information provided by a user (such as location, building type, etc.), and other analyses to validate that the obtained copy of the target building code can be used (e.g., is suitable for translation by the model into a programmable script). This analysis may be performed at least in part by comparing obtained building code and corresponding information to a set known verified data and/or by processing the obtained building code to a set of predefined conditional rules. For example, the analysis may include identifying the sections of a corresponding verified building code, identifying the sections within the obtained building code, and comparing the identified sections to determine whether the obtained building code has each section of the verified building code and, thus, can be presumed to be complete. As another example, the analysis may include identifying a date or version of the obtained building code, and accessing a government or other third-party data source (e.g., a server) to confirm that the obtained building code is current. The analysis may also include identifying errors in the obtained building code. For example, the analysis may include accessing example sections of a corresponding verified building code and comparing corresponding sections of the obtained building code to the accessed example sections to confirm that they match.

At block 408, process 400 may initialize a model to recognize the determined programming language. This step may involve loading or providing the foundational grammar and syntactical rules associated with the programming language to the model (e.g., the translator 105, code generator 232, or code translation model/interface 524 (of FIG. 5)). This loading can ensure that the model can correctly interpret and generate outputs in that language. For example, where Prolog or Picat is the designated logic-based programming language, the process may load predefined templates, clauses, and sample scripts that illustrate basic compliance-checking logic. These examples may include foundational operations such as numerical comparisons, logical condition evaluations, and clause structuring, which serve as a framework for the model's operations. Examples of rules statements, definitions, and similar snippets of code written in the programming language may also be provided.

Models that may be trained or initialized in this manner include generative models, such as large language models like ChatGPT, Llama, etc. Generative models, particularly large language models and generative transformer models, can be initialized to understand syntax and usage of a given logic-based programming language by fine-tuning them with information about the desired programming language and how it might be utilized in the particular task of building code translation. These models are pre-trained on a vast dataset of natural language and structured data, which often includes examples of programming languages. However, in the inventors' experiments, simply prompting a pre-trained LLM (without first fine-tuning, such as in a task-specific fashion) to translate building code text into a logic-based programming language, does not yield workable results. For a task like translating building code requirements from native written language to logic-based programming, a zero (or very low) error rate tolerance may be used for some embodiments. This limited tolerance is because, once construction of a building commences, not all facets of the building can be subsequently changed or fixed (at least not without substantial delay and expense). Accordingly, simply using pre-trained models (or not fine-tuning a model in a particularized manner such as disclosed herein) would likely result in inconsistencies and error rates that would render usage of the model inefficient or pointless for purposes of automated translation (given that a human may still need to check some or all of the output of the model and correct any errors).

To enable pretrained models to process building code text and then accurately and reliability translate the requirements of that code into generated logic-based programming, the inventors have found that particularized fine-tuning can or should be used. As noted above, providing a pretrained model with curated information and particularized training examples (e.g., datasets containing examples of syntax, grammar, and functional applications specific to the desired language, such as Prolog or Picat) can modify the model in a manner that allows it to satisfy error tolerances and output requirements of building code translation implementations. In one sense, this particularized fine-tuning involves a form of ‘supervised’ learning (whereas pre-trained models are generally pre-trained in an unsupervised manner) in which input prompts (e.g., building code requirements in natural language) are paired with corresponding outputs (e.g., logic-based representations) as examples in addition to prompt guidance and syntax structure. In other words, in addition to providing supervised training examples, techniques such as prompt engineering can further refine the model's behavior toward a more predictable, consistent, and usable result. For example, crafted prompts may be utilized to steer the model's behavior toward expected correct and contextually relevant outputs-which is made more practical when a logic-based programming language is used which can promote precision and clarity. Block 408 may also involve reinforcement learning, where the model is rewarded for generating syntactically and semantically correct logic scripts. At this stage, rather than tuning the model specifically to generate translations of building code requirements, the model may first be trained simply to generate correct and sensible code/scripts.

Initializing the model may also include incorporating user-provided or pre-configured prompts that are tailored to usage of the desired programming language in ways that will satisfy anticipated requirements. This may further entail defining the structure, approach, and/or syntax of various rules, operator priorities, or rule hierarchies that will be relevant to the building code's logical constructs, content, and/or requirements.

Accordingly, initializing or training the model in the manner described herein provides an improved model that generates more accurate outputs, and outputs that are usable in industry. In contrast, generic models without such initialization or training provide inferior results, which may be unusable in industry without substantial manual review and correction.

At block 410, process 400 may involve generating an initialization prompt and obtaining examples to fine-tune a large language model (LLM) for translating building codes into logic-based programming scripts. This may include creating a structured set of input-output pairs that exemplify the transformation of natural language building code clauses into corresponding logic statements. For instance, a clause, such as, “An exit door shall have a minimum width of 36 inches,” might be paired with a Prolog statement defining a rule for minimum door width compliance. In some embodiments, the initialization prompt and examples may be specific to the target building code of interest, which can promote more accurate and faster training and give developers better insight into how quickly and accurately the model is being tuned. In other embodiments, the target building code may be categorized by certain attributes or metadata (e.g., by jurisdiction, promulgating organization, subject matter, etc.) and initialization prompts/examples may be selected from a predefined library of initialization tools which correlates to the target building code.

The initialization prompt may be configured to fine tune and modify the model and its behavior by clearly defining the goals and task, output attributes, and identifying or emphasizing any facets of the building code that may be preserved (e.g., accurately reproducing numerical values, thresholds, and ranges; and logical dependencies inherent in the building code). In some embodiments, multiple prompts may be pre-defined or available, which can be sequentially selected and/or adjusted based on the model's initial outputs and performance, to enhance its translation accuracy relative to the target building code of interest.

The process may access a database of initialization prompts created and stored in advance of execution of the process 400. The initiation prompts may be categorized for lookup. For example, each initialization prompt may be associated with a particular programming language (e.g., having a set up examples of proper translation of natural language building codes to that programming language) and/or a building code type (e.g., electrical, fire protection, structural, exterior appearance, etc.). During the process 400, to generate the initialization prompt in block 410, the process may access the database with a request identifying the programming language and the building code type, and receive the initialization prompt in response. The process may further include providing the initialization prompt to the model (e.g., the model already initialized in block 406) to further initialize or train the model.

Accordingly, this additional initializing or training of the model at block 410 also provides an improved model that generates more accurate outputs, and outputs that are usable in industry. In contrast, generic models without such initialization or training provide inferior results, which may be unusable in industry without substantial manual review and correction.

At block 412, process 400 may include generating an initial programming script using the fine-tuned model. For example, the process may include providing a prompt to the initialized model that including an indication of the target building code for translation (e.g., with a pointer to an electronic file encoding the building code or with the building code itself), an indication of the programming language into which the code should be translated, and/or a request to perform translation of the target building code to the programming language. In some examples, the prompt may include the initialization prompt generated in block 410 (e.g., if not provided in advance at part of block 410).

Block 412 further includes receiving the script from the model. The script would be expected to have the format/syntax of the desired programming language, and to describe logic-based analyses and rules that encapsulate the building code requirements. For example, given a target building code specifying “maximum building height of 60 feet,” the generated script might include a fact indicating this height and a rule for comparing building height inputs to this threshold. The initial script may also include comments or explanations for debugging and validation purposes, which can later be refined or removed.

The generated script may be subjected to a preliminary evaluation to identify areas for improvement, such as errors in syntax, misinterpreted logical conditions, or omissions of constraints. In some embodiments, this evaluation may be performed automatically, leveraging predefined tests or benchmarks that assess the script's functional correctness. For example, a library of pre-analyzed building code sections may include corresponding initialization prompts and “gold standard” programming scripts that are known to correctly and accurately embody the code requirements. Using these code-script pairs, the model's performance and behavior can be automatically evaluated during training.

At block 414, process 400 may involve testing and refining the generated programming script. This step may include a functional equivalence check, where the script is compared against known-correct logic for a building code, to ensure that it achieves the same compliance-checking outcomes. For example, where a model is initialized and trained on a given building code (e.g., from a pre-selected training set of building codes), the model can then be tested and validated on the desired/target building code, or vice versa. Discrepancies may be addressed through iterative refinement, wherein additional prompts or corrections are used to guide the model toward a more accurate translation. Such prompts can be provided to identify a discrepancy and request that the model revise the code to correct the discrepancy. The prompts can be provided to the model, resulting in a revised programming script. Each such revised programming script may be referred to as an intermediate programming script (having been generated after the initial programming script and before the final script).

At block 416, process 400 may determine whether the refined code or script is sufficiently similar to a predefined “gold standard” script. This determination may be made using one or more of several techniques. First, a set of test inputs may be provided to the script to determine from a functional standpoint whether or not it outputs what may be the correct result every time, most of the time, some of the time, etc. For example, where a building code rule sets forth that a given number of smoke detectors may exist for every door/square foot/etc. of a building, a test input/output pair may be provided to the code/script in which it is known that not enough smoke detectors are being used for the design. As another example, rather than evaluating the script from a standpoint of functionality, it could be evaluated by comparison to a script that is known to accurately embody the underlying building code rule. For example, this comparison may involve comparing the refined script to a reference using text similarity metrics such as Levenshtein Distance or Jaccard Similarity. Furthermore, an LLM may be utilized to narratively describe what the refined code or script will do in operation, and compare that to the associated building code sections so that a user can manually verify that the code accurately captures concepts of the original building code text/sections. In further embodiments, any or all combinations of these approaches may be utilized together. If the script is not sufficiently similar, process 400 may loop back to block 414 for further refinement.

In some embodiments, at block 418, the process 400 may also include automated debugging to identify and correct syntax errors or logical inconsistencies. This may be performed in association with block 414, block 416, or as a separate block 418.

Upon determining that the generated script has sufficient similarity, the process 400 may proceed to the next block.

At block 420, if it is determined that a generated script is accurate enough or sufficiently similar to a gold standard, then process 400 may involve augmenting the refined script with compliance-checking functions and conducting a final validation. This augmentation may include adding built-in functions for handling unit conversions, conditional logic, or advanced numerical comparisons. These functions enhance the script's utility by enabling it to process a wider range of compliance scenarios efficiently. The final validation may include executing the script in a test environment to verify its readiness for deployment in compliance-checking systems. This validated and augmented refined script may be the final programming script produced by the process.

The final programming script, also referred to as a compliance script, may be stored as an executable. In some examples, the method further includes executing the final programming script to process an input building plan and generate an indication of whether the building plan complies with the applicable building code. In some examples, the method may distribute the final programming script to one or more end-users via a communications system. For example, with reference to FIG. 5 (discussed further below), a computing device 510, which may execute the process 400 to generate the final programming script, may transmit the final programming script via a communication systems 518 to one or more computing devices of end user(s) (e.g., of end-companies 526, 527) via a communication network 530. The end-user(s) may execute the final programming script to process an input building plan and generate an indication of whether the building plan complies with the applicable building code.

### Example Systems, Networks, and Platforms

FIG. 5 is a conceptual block diagram illustrating a system 500 for implementing the improvements, algorithms, and processes described herein. In one respect, the system 500 can be thought of as an integrated platform for managing building codes and code updates, and automatically generating compliance-related software solutions. In another respect, the system 500 can be thought of as a dynamic network for exchanging, receiving, analyzing, and disseminating updated building code information and related compliance materials among a variety of parties.

The illustrated system 500 can, thus, include components that are end-user facing (e.g., web portals or software-as-a-service (SaaS) offerings); developer-focused (e.g., a system or network of a company that provides building code compliance software and/or updates); or government facing (e.g., systems that review building applications for code-compliance, and/or which validate text of new proposed code amendments); and components that have a more ‘backend’-focused role, such as drawing data from multiple sources, formatting and debugging code, packetizing software updates, etc.

As shown, a computing device 510 is provided for performing one or more of the aspects of processes and algorithms described herein such as that of FIG. 4. Thus, computing device 510 can be a device, network, or other resource that includes an integrated circuit (IC) or processor for computation, such as a server, cloud resource, or any suitable computing resource. In some examples, the computing device 510 can be a special purpose device (e.g., a machine or co-processor, or including an ASIC) that can efficiently compute building code analysis software such as described herein, such as by running or interfacing with a trained model.

As described below, the device 510 has a specific set of monitoring, processing, and communication adaptations to allow it to perform processes contemplated herein. Thus, for example, the processes 300 and 400 described in FIGS. 3 and 4 can be implemented for or by a special-purpose device.

In the system 500, a computing device 510 includes a data communications link or system 518 such that it can retrieve building code updates, regulatory changes, and new standards from entities 502. These entities may include governmental organizations, industry trade associations, and regulatory bodies that promulgate building codes, regulations, and standards. For example, the computing device 510 may interface with public or secure repositories maintained by entities 502, including websites, subscription-based databases, or APIs, to obtain updates. In some embodiments, these entities 502 may also provide draft amendments or proposals for upcoming changes, enabling the system to notify users of impending compliance requirements.

The computing device 510 can include a memory 514. The memory 514 can include any suitable storage device or devices that can be used to store suitable data (e.g., a database of building code information, a trained machine learning model, a neural network model, a software application running a user interface, an integration to various building/architectural software, etc.) and software instructions that can be used, for example, by the processor 512. The memory 514 can include a non-transitory computer-readable medium including any suitable volatile memory, non-volatile memory, storage, or any suitable combination thereof. For example, memory 514 can include random access memory (RAM), read-only memory (ROM), electronically-erasable programmable read-only memory (EEPROM), one or more flash drives, one or more hard disks, one or more solid-state drives, one or more optical drives, etc., or may simply be an apportioned cloud, network, or other resource. In some embodiments, the processor 512 can execute at least a portion of processes 400 described above in connection with FIG. 4.

The computing device 510 can further include a communications system 518. The communications system 518 can include any suitable hardware, firmware, and/or software for communicating information over the communication network 530 and/or any other suitable communication networks. For example, the communications system 518 can include one or more transceivers, one or more communication chips and/or chip sets, etc. In a more particular example, the communications system 518 can include hardware, firmware and/or software that can be used to establish a Wi-Fi connection, a Bluetooth connection, a cellular connection, an Ethernet connection, etc.

The computing device 510 can receive or transmit information (and/or any other suitable system over a communication network 530. In some examples, the communication network 530 can be any suitable communication network or combination of communication networks. For example, the communication network 530 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 530 can be a local area network, a wide area network, a public network (e.g., the Internet), a private or semi-private network (e.g., a corporate or university intranet), any other suitable type of network, or any suitable combination of networks. Communications links shown in FIG. 5 can each be any suitable communications link or combination of communications links, such as wired links, fiber optic links, Wi-Fi links, Bluetooth links, cellular links, etc.

In some examples, the computing device 510 can further operate, support, interact with, or enable a developer interface 520. The connection to such an interface may be part of or rely upon a network connection such as the communication link 530, but alternatively may be a separate connection such as, e.g., a private connection to an organization's internal network or may include other connections such as direct connection to user input/output devices like a display monitor, keyboard, etc. The developer interface 520 may in some examples be a software-based user interface, such as one that provides a platform for software developers to perform various functions for implementing and maintaining the invention, particularly in scenarios where continuous monitoring and dynamic updating of building codes may be used.

The developer interface 520 may allow for a user to monitor and control various aspects of how processes contemplated herein are performed. For example, interface 520 may allow a developer to input information that will be used to configure or select specific settings, such as specifying the programming language or languages to be used for generating compliance scripts. For instance, the interface may provide a prompt or window for the developer to choose a logic-based language like Prolog for certain jurisdictions due to its clarity and rule-based syntax or select Python for integrations with modern APIs. Additionally, the developer interface 520 may be configured to allow for the creation of custom mappings between elements of building codes and specific logical operators or structures relevant to the chosen programming language, so as to mandate how the code written by a model such as developed via process 400 drafts its outputs.

The interface may also provide tools for reviewing the performance of translation models that have already been trained or which are being trained. For example, the developer interface may display outputs of one or more iterations of a building code translation model (and/or comparison to previous models) so as to allow a user to monitor accuracy and consistency, and/or to compare them in a functional way against reference outputs or “gold standard” compliance scripts. Thus, the interface may allow the user to directly provide modified outputs for reinforcement/retraining, or otherwise cause refinement of the model's performance. Developers might use the interface to provide additional training examples, such as code fragments or logic statements, that are tailored to specific building code provisions. This could involve submitting edge cases, ambiguous scenarios, or complex regulations to enhance the model's ability to handle a diverse range of inputs.

In scenarios where the system 500 monitors for new building code changes, the developer interface 520 may present tools or visualizations to assist in assessing the nature and/or significance of detected changes. For example, the system may monitor a governmental or trade association website or online repository, or a service that publishes notices of rule changes, etc., and detect when the content of a webpage, document, or other resource (e.g., a PDF document posted on a website, textual content of HTML, etc.) containing a building code, regulation or standard has been changed. The developer interface 520 may display summaries of detected changes generated by an LLM or other analysis module. These summaries may identify sections of the code that have been modified, added, or removed. The interface may also allow developers to classify these changes, such as distinguishing between substantive updates—like modifications to safety requirements—and changes that are more stylistic or format-related, or which may have been caused by updates to the online resource itself. Based on this classification, the interface may provide options to initiate or delay the distribution of compliance script updates to users 526, 527.

The interface 520 may also support workflows for extending or modifying the system's capabilities to address new programming languages requested by user-companies 526, 527. For example, in some embodiments, the user interface may present to developers a tailored display and interactive input and selection tools/windows to obtain from the developer information useful for creating, updating, modifying, controlling, and selecting features and steps of processes contemplated herein, such as generating, modifying, and inputting training prompts for models to learn programming languages and particular syntax, to tailor new example inputs/outputs that align with the syntax and semantics of a requested language and associated desired code(s)/standard(s). Additionally, the interface may display options for updating or verifying existing training and refinement examples, linking to new examples, or the like, which could be used to adapt the system to handle new jurisdictions or specific use cases.

In some embodiments, the interface may further support workflows for approving updates before they are pushed to end-users. This might include: allowing a user to select desired jurisdictions, trade associations, standards, regulations, codes, statutes, governmental guidance, safety certifications, manufacturer instructions, governments, municipalities, proposed rulemaking, announcements of changes, or other sources of information relevant to building design compliance checking, which can be monitored for potential changes; monitoring resources associated with these monitored sources (e.g., monitoring websites, legal reporters, etc.) to determine whether a change to the associated code/etc. has occurred; presenting to a user an indication that a possible change has occurred for a monitored source of information (e.g., displaying a copy of the given code/etc. highlighting potential changes; displaying a comparison of prior vs updated versions; generating a summary of changes via LLM, etc.) and/or prompting a user to determine whether a given change warrants publishing a software update; if so, initiating a workflow for the developer to follow in which the updated code is processed by a trained model (e.g., a result of process 400) to generate an updated script; providing for debugging and validating the generated updated script, visualizing compliance logic, and/or simulating compliance-checking scenarios based on the generated scripts for approval by the developer. These features enable developers to maintain a high standard of quality and reliability for the compliance tools provided to user-companies 526. In further embodiments, some or all of these steps may be automated.

The memory may further store a code translation model or interface 524 (model 524). The model 524 may be an example of the translator 105 and code generator 232). The model 524 may include an LLM to perform the translations of building code to scripts, as discussed herein (e.g., with respect to FIGS. 1-4). In some examples, one or more of the modules within the memory 514 (the developer interface 520, building code analysis 522, and/or the model 524) may be or include software instructions that can be executed by the processor 512 to perform the functionality thereof (e.g., the processor 512 may execute the software instructions of the model 524 to implement the LLM that translates building codes to scripts).

In some examples, a building code analysis module 522 may be utilized to monitor and analyze building codes, standards, etc. both for purposes of use in generating code scripts but also (or alternatively) for monitoring changes to those codes/etc. For example, module 522 may comprise a background process or script that regularly: (i) fetches and analyzes the content of given websites or other resources; (ii) conducts searches and performs natural language processing to determine information suggesting that a new code/etc. has been promulgated or amended that is relevant to jurisdictions or businesses of the user base; (iii) analyzes resources that were determined to possibly exhibit code/etc. changes, and compare to previously-processed versions of that same code/etc. (whether via LLM, word by word comparison, distance measurements, etc.); (iv) processes the changed portion of the code/etc. via an LLM to generate a narrative summary of the change to provide to a user; (v) generates a script based upon the changed content, and compare the generated script to a stored version of the previous script (e.g., from database of generated code and software updates) for the same portion of the same code/etc. (whether functionally, by distance measurement, or other technique as described above); (vi) if the generated script performs functionally different than the previous script, generates an alert to a user that a software update can be published; and (vii) engages in a script debugging and validation process to confirm the updated generated script performs accurately, store records of the change, prior version, rationale for change, and a copy of the updated code/etc., before publishing the update according to company policy.

In some embodiments, module 522 may include a Python or JavaScript based web scraping tool; a script that receives and monitors RSS feeds or APIs; content monitoring tools that monitor websites for changes. Where module 522 determines that a modified code version exists on a website or resource, the system may also allow for a developer to confirm an LLM's assessment of whether the modified code version is fully enacted or merely proposed; the jurisdictions and businesses to which the modified code version would apply, etc.

The computing device 510 can therefore generate compliance software updates 516 and distribute these updates to a plurality of user-companies 526, 527. To distribute the compliance scripts and/or updates, the computing device 510 may transmit the compliance scripts and/or updates via the communications system 518, via the communication network 530, to recipient computing devices (e.g., user companies 526, 527). User companies 526, 527 may represent user computer devices of respective user companies having processors configured to receive software updates 516 and execute compliance software as updated based on the compliance updates 516. These updates 516 may include compliance scripts, narrative descriptions of code changes, and notifications of proposed new rules. Users 526, 527 may specify preferences such as relevant jurisdictions, types of building materials, or trades, allowing the updates to be customized to their needs.

### Examples and Validation Experiments

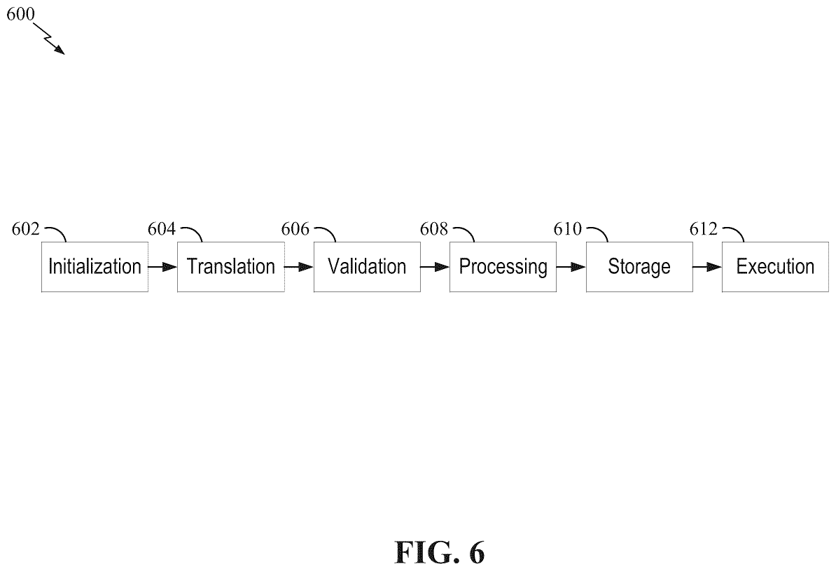

Experimental procedures were performed by the inventors to validate the automated building code translation model. In particular, the workflow for the experiments followed a systematic approach to ensure consistency, accuracy, and reliability in the translation process. FIG. 6 illustrates an example process 600 used for the experiments, which includes six steps. Initialization 602 includes the set-up of the GPT-based translator with foundational information. Translation 604 includes providing the input text (building code requirements or even crash report descriptions) to the translator along with specific prompts to generate the initial programming script. Validation 606 includes performing one or more functional checks by comparing the generated script with a manually written counterpart. In some examples, the output is refined with additional prompts if discrepancies are found until functional equivalence is achieved. Processing 608 includes removing natural language explanations from the script using regular expression algorithms. In some examples, a grammatical check may be conducted to debug and refine the script into the gold standard. Storage 610 includes saving the requirement/report and its corresponding gold standard as key-value pairs. In some examples, the final programming script may be saved as Picat files. Execution 612 includes executing the script within the Picat programming environment. In some examples, the output may be evaluated based on predefined criteria.

To provide an understanding of the experimental setup and evaluation criteria, Table 2 presents an overview of specific changes in parameters and approaches for each experiment. Moreover, Table 3 provides the length characteristics of the two datasets. The building code translation dataset contains longer texts, with an average length of 162.9 characters compared to 98.2 characters in the crash report translation dataset. The standard deviation indicates more variability in text length within the building code translation dataset (49.82) compared to the crash report translation dataset (24.84). Overall, the building code translation dataset is characterized by longer and more variable text entries, likely reflecting the detailed and complex nature of building code descriptions. In contrast, the crash report translation dataset consists of shorter and more consistent text entries, possibly due to the more straightforward and flexible nature of crash narratives. Both experiments were conducted using a laptop with an 11th Gen Intel Core i7-1185G7 central processing unit (CPU) and 16.0 GB of random-access memory (RAM).

TABLE 2
Comparison of parameters and approaches for each experiment.

| Parameter/Experiments | Building code translation | Crash report translation |
|---|---|---|
| Initial Translation | GPT-based translator | Refined model after building |
| Model | | code translation |
| Dataset | 51 quantitative fire protection | 20 quantitative descriptions from |
| | system requirements from IBC | 2022 Michigan state traffic crash |
| | 2015. | data. |
| Input dataset nature | Formal regulatory language | Narrative natural language |
| Example rule | “An automatic sprinkler system | “Unit one driver stated he was |
| | shall be provided where multiple | traveling at 45-50 miles per hour, |
| | fire areas of Group A-1, A-2, A- | due to inclement weather.” |
| | 3 or A-4 occupancies share exit | |
| | or exit access components and | |
| | the combined occupant load of | |
| | these fire areas is 300 or more.” | |
| Domain Specificity | Fire protection systems, building | Vehicular accidents, crash |
| | codes | reports |
| Quantitative Focus | Occupant load, sprinkler system | Speed, distance, time, breath test |
| | requirements, spatial distance, | results, etc. |
| | etc. | |
| Initial prompt | “Based on the example you have, | “Can you translate the following |
| | can you convert the following | crash report into logic |
| | building code clause into logic | programming code? Please |
| | facts and rules? Please | concentrate on quantitative |
| | concentrate on quantitative | information. Here is the crash |
| | requirements and adhere to the | report description: . . . ” |
| | provided format. Here is the | |
| | building code clause: . . . ” | |
| Output | Initial programming script with | Initial programming script |
| | logic facts and rules. | encapsulating factual elements of |
| | | the accident and logic rules for |
| | | compliance. |
| Functional check | Compare generated script against | Ensure rules accurately filter out |
| | a manually written counterpart | facts that conform to crash report |
| | which represents the specific | descriptions. |
| | requirement. | |
| Refinement process | Additional prompts to address | Additional prompts to address |
| | discrepancies | discrepancies |
| Grammatical check | Debug and refine into the gold | Debug and refine into the gold |
| | standard | standard |
| Storage Method | Save as key-value pairs in the | Save as key-value pairs in the |
| | example rules | example rules |
| Final script storage | Picat files | Picat files |
| Execution environment | Picat programming environment | Picat programming environment |
| Evaluation metrics | Functional equivalence, accuracy | Functional equivalence, accuracy |
| Total output files | 100 Picat code files (2 per | 40 Picat code files (2 per crash |
| | requirement: gold standard and | report description: gold standard |
| | functionally equivalent code) | and functionally equivalent code) |

TABLE 3
Comparison of length information between
two experimental datasets.

| | Building code | Crash report |
|---|---|---|
| Dataset length information | translation | translation |
| Min length | 76 | 47 |
| Average length | 162.9 | 98.2 |
| Max length | 272 | 144 |
| Standard Deviation | 49.82 | 24.84 |
| Confidence Intervals (95%) | [147.74, 177.06] | [86.57, 109.83] |

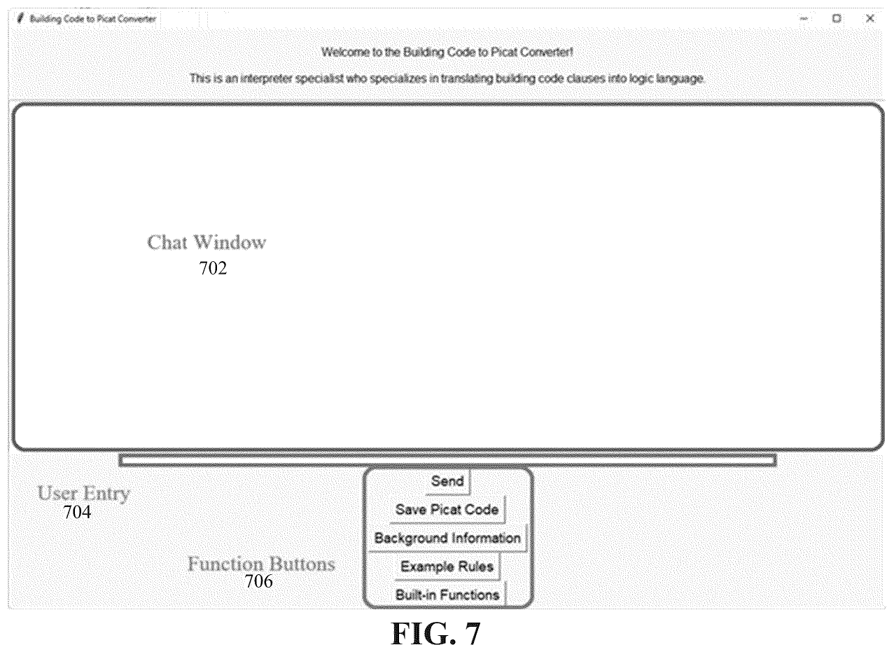

In some examples, to implement the proposed framework, a user interface platform based on an executable file is developed, as depicted in FIG. 7. This platform comprises: a chat window 702, a user entry field 704, and function buttons 706, each designed to fulfill specific operational roles. The chat window 702 serves both to display responses from the backend module and to display a chat history (e.g., showing user prompts and model responses). The user entry 704 field allows for the input of tasks and prompts by users. The function buttons 706 are engineered to execute various tasks. In particular, the “Save Picat Code” function processes the generated code into the final programming script. The “Background Information” function provides access to foundational knowledge about the target logic programming language, Picat, including its grammar and reasoning mechanisms. The “Example Rules” function of the function buttons 706 is designated for displaying and storing example rules and the gold standard. In some examples, rules may demonstrate to the translator a method of analyzing building code requirements and translating them into specific logic language expressions. Alongside the initial example rule, gold standards developed throughout the experiments are also archived here as example rules, some or all organized within a Python dictionary with building code requirements as keys and their corresponding logic programming code as values. This accumulating repository of example rules enriches the database, progressively enhancing the model's performance. Moreover, “Built-in Functions” of the function buttons 706 store built-in functions that aid in unit comparisons and conversions as well as time counting. In some examples, the functions of the function buttons 706 may be used to rectify unit inconsistencies in building regulations and design information, thereby facilitating the compliance checking process. This user interface platform simplifies interaction with the translator, enabling users to review, process, and store the final programming script efficiently.

The efficacy and adaptability of the proposed framework were evaluated through two distinct experiments. To assess efficacy, fifty-one specific building code requirements from Chapter 9 of the International Building Code 2015 (IBC 2015) were selected for automatic translation into Picat logic programs to support logic reasoning and compliance verification. Chapter 9 of IBC 2015 covers the requirements for building fire protection systems and includes 16 sections detailing automatic sprinkler systems, standpipe systems, smoke control systems, etc. The provisions related to quantitative requirements were chosen for this experiment because: 1) these clauses have clear logical relationships that facilitate the implementation of automatic reasoning, and 2) the quantitative requirements provide guidance for space configuration in buildings and building fire protection systems. An example of a provision used as a test case is “openings shall have a minimum dimension of not less than 30 inches” (Provision 903.2.11.1.1), which included “30 inches” as the main quantitative requirements for the dimensions of openings.

For the adaptability assessment, the platform was applied to the translation of twenty crash descriptions from the 2022 Michigan state traffic crash data into Picat logic programming language, illustrating the methodology's versatility. The crash descriptions were manually selected, following the same criteria used for the selection of building code provisions, to determine if the translator could effectively grasp the logical relationships and quantitative descriptions present in another natural language document (i.e., crash reports). The quantitative descriptions of crash accidents are fundamentally different from those in building codes. Quantitative information from crash reports included time, speed, preliminary breath test (PBT) results, etc. For example, “unit one driver stated he was traveling at 45-50 miles per hour, due to inclement weather”, included the speed “45-50 miles per hour” as the main quantitative information. Further details of these experiments are discussed in subsequent sections.

For this experiment, fifty-one quantitative fire protection system requirements were selected from the IBC 2015. In the experiment, one requirement was designated as an example rule (training data), whereas the remaining requirements served as test cases. The selection of the training data for this experiment was meticulously guided by several key criteria to ensure the effectiveness of the chosen example rule in training the GPT-based translator. First, the complexity of the example rule was a factor. The rule may embody complex concepts and logical relationships to serve as a challenging yet instructive training example for the GPT model. By including such complexity, the example rule could effectively train the model to understand and represent intricate building code requirements. The example rule had to contain specific quantitative elements to align with the experiment's focus on translating quantitative fire protection system requirements. This alignment ensured that the model was trained to handle numerical data accurately within the context of logic programming. Moreover, the illustrative value of the example rule was a significant criterion. The rule was chosen for its ability to clearly illustrate the application of logic facts and rules, making it an ideal example for the model to learn from. By providing a clear and instructive example, the rule facilitated the model's learning process, enhancing its ability to translate similar building code requirements effectively.

The example rule: “An automatic sprinkler system shall be provided where multiple fire areas of Group A-1, A-2, A-3 or A-4 occupancies share exit or exit access components and the combined occupant load of these fire areas is 300 or more,” illustrating the requirement for automatic sprinkler systems in certain occupancy groups with a combined occupant load of 300 or more, was accompanied by corresponding logic facts and rules. The logic rules emphasize the assessment of occupant load to determine the necessity for sprinkler system installation, categorizing scenarios into compliant or non-compliant based on the occupant load.

Upon initializing the translator, a new building code requirement is provided as input. The translator is then prompted with Question (1): “Based on the example you have, can you convert the following building code clause into logic facts and rules? Please concentrate on quantitative requirements and adhere to the provided format. Here is the building code clause: . . . ”

The prompts used in the experiments were designed to mimic natural language as used by non-experts, aiming to make the translator user-friendly. The key considerations behind the design included: 1) emphasizing specific numerical values or measurements within the building code clauses, 2) using simple and clear language to avoid ambiguity, and 3) maintaining a consistent structure across some or all prompts to facilitate comprehension and processing by the translator. An example of a successful prompt follows the form of “Question (1)+a specific building code requirement,” such as: “Based on the example you have, can you convert the following building code clause into logic facts and rules? Please concentrate on quantitative requirements and adhere to the provided format. Here is the building code clause: ‘Openings shall have a minimum dimension of not less than 30 inches.’”

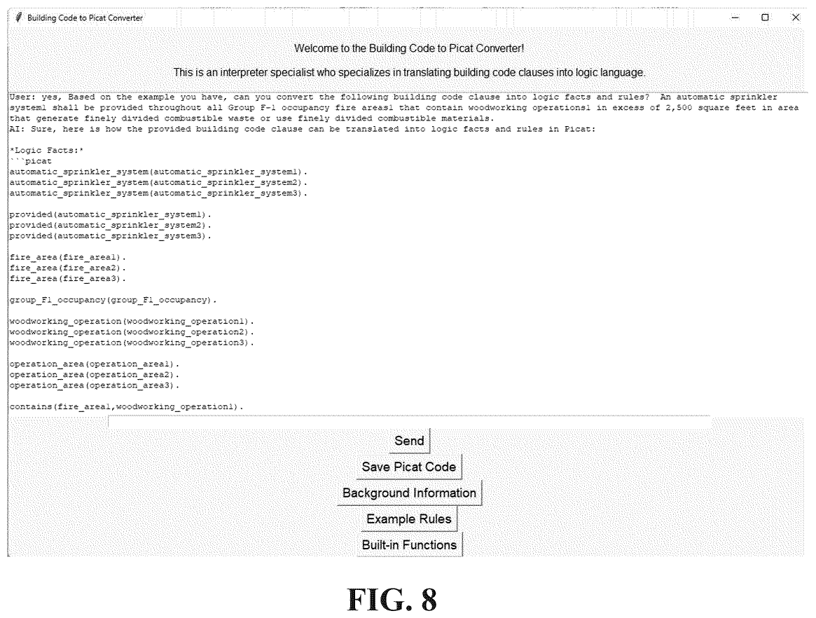

Unsuccessful prompts were generally ambiguous or introduced new concepts, causing the translator to be confused or misunderstand the target, or resulting in outputs that did not follow the given format. For example: “Convert this building code into logic rules: ‘Openings shall have a minimum dimension of not less than 30 inches.’” This prompt does not specify the focus of scope (i.e., quantitative requirements) or clearly state the format to be followed. Due to the creativity of the GPT model, the output of the translator is not satisfactory in this case. FIG. 8 shows a screenshot of the dialog interface in the experiment. Following this, the generated programming script is subjected to functional and grammatical checks to ensure its readiness as an executable program. The functional check compares the generated script against a manually written counterpart for functional equivalence, necessitating further prompts for error correction until functional equivalence is achieved. Subsequent to functional validation, the script, typically containing natural language explanations such as “Here is the generated code: . . . ”, undergoes processing via regular expression-based algorithms to extract the code. This code then undergoes a grammatical check for debugging and refinement into the gold standard.

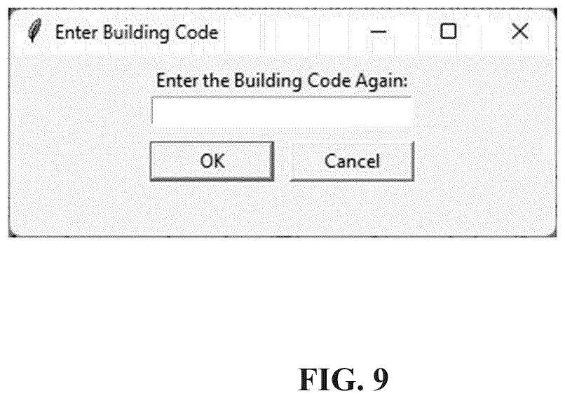

By utilizing the “Save Picat Code” function, users may re-enter the building code requirement, facilitating the storage of the requirement and its corresponding gold standard as key-value pairs in the example rules, as shown in FIG. 9. Consequently, the size of the example rules set increases as the experiment progresses. These updated example rules serve to progressively enhance the model's performance for future tasks. Additional functions are automatically integrated into the gold standard, guiding users to save the final programming script as a Picat file on a computer device. Users can then execute this script within the Picat programming environment. In one example, the translator may formulate logic rules for a building code requirement, generating three instances for logic reasoning, where two met the compliance criteria, and one did not. Throughout the experiment, each of the fifty test building code requirements was processed in this manner, yielding a total of one hundred Picat code files for evaluation, with two files generated for each requirement: a gold standard and a functionally equivalent code.

Following the building code translation experiments, the refined model was further employed to convert crash reports into logic programming scripts without any adaptations on the structure of the model. These reports, compiled by police officers based on witness testimonies from automobile accidents, present detailed information in natural language. The transformation of these narratives into machine-readable formats, such as logic programming scripts, is advantageous for reconstructing vehicular accidents. Given the distinct linguistic characteristics of crash reports compared to building codes, these reports serve as an appropriate medium to assess the model's versatility.

For this experiment, twenty crash reports containing quantitative data on variables such as speed, distance, time, and preliminary breath test (PBT) results were manually selected as test cases. Each data was introduced to the model with a specific prompt (Question 2): “Can you translate the following crash report into logic programming code? Please concentrate on quantitative information. Here is the crash report description: . . . ”

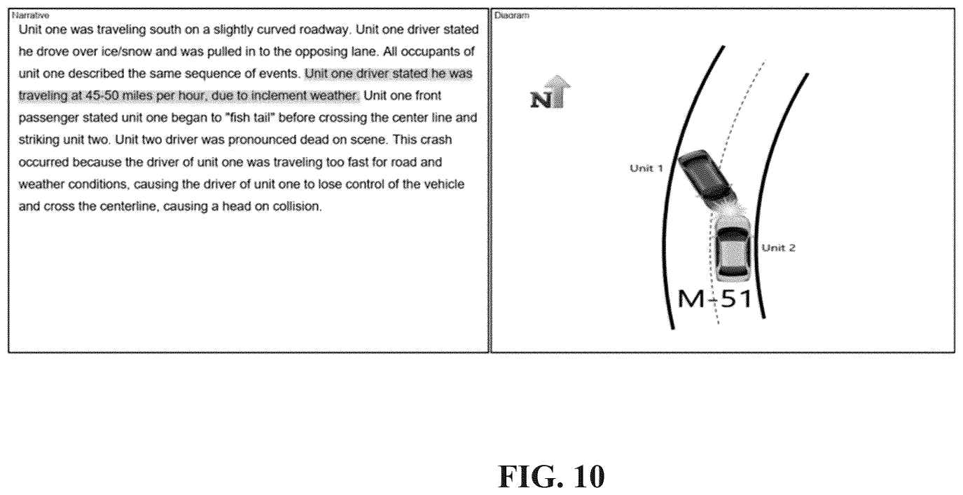

The translation process follows the framework applied in the building code translation, aiming to generate a final programming script for each crash report description. The translator was tasked with creating multiple logic facts to encapsulate the factual elements of the accidents and devising logic rules to ascertain compliance with the crash report narratives. The functional check of the generated programming script is based on whether the rule can accurately filter out the facts that conform to the description of the crash report. FIG. 10 illustrates an example of this translation process, highlighting a crash report description alongside its resultant code. This particular example concentrated on verifying the compliance of simulated driver speeds with the speeds reported. Upon conclusion of this experiment, a total of forty Picat code files were compiled from the twenty crash report descriptions for comprehensive evaluation.

Upon submitting the initial task request through the prompt, the process records the number of additional prompt rounds until the generated code achieves functional equivalence with the manually written script, crafted to encapsulate the nuances of building code concepts and requirements comprehensively. Table 4 illustrates the distribution of these additional prompts across 50 test cases, revealing that the maximal number of prompt rounds used is four, with 32 cases achieving functional equivalence without necessitating any further prompts. This indicates a high accuracy of the translator in interpreting and converting building code information into programming script. A detailed number of further prompts may be used in each experiment, as shown in FIG. 8. The variation in the number of additional prompts is attributed primarily to the different complexities of the building code requirements. Through results analysis the main issues which may require further prompts are identified as follows: 1) omission of key building code concepts or their relationships in logic facts, 2) direct comparison of quantities without employing built-in functions for numerical comparisons with units, 3) undefined predicates in logic rules, 4) failure to define at least two instances to evaluate logic rules in compliant and non-compliant scenarios respectively, 5) absence of logic rules for identifying instances of non-compliance, 6) overlooking checks for quantitative requirements, and 7) logical inaccuracies, such as misinterpretation that noncompliance indicates the failure to meet some or all/both conditions when there are more than one conditions, such as the example conditions “greater_than_or_equal(VestibuleArea, min_net_area_threshold)” and “greater_than_or_equal(OuterSpaceWidth, min_width_threshold)”, where failing to meet one of them can be considered as noncompliance. These challenges may stem from the inherent complexity of building codes, the task's difficulty, and the translator's variability in performance. However, these issues can be addressed with further prompts that clearly indicate errors in the model's responses, suggest revisions, and request next steps. As the experiment progresses, these issues are gradually reduced. Overall, one or more translations can achieve functional equivalence within two rounds of prompts, which is considered acceptable in practice.

TABLE 4
Distribution of the number of further prompts
used in building code translation.

| Number of further prompts | 0 | 1 | 2 | 3 | 4 |
|---|---|---|---|---|---|
| Count | 32 | 7 | 9 | 1 | 1 |

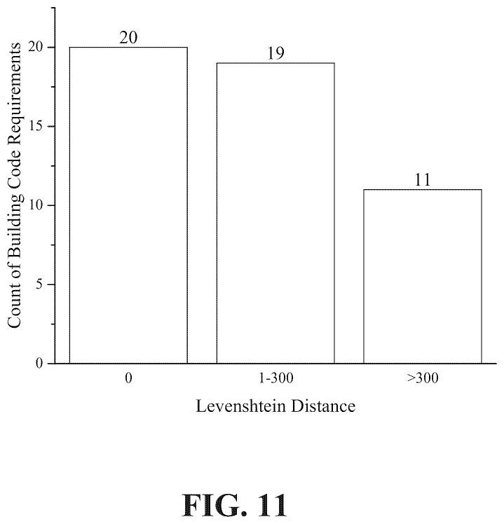

Upon reaching functional equivalence, the generated code, with comments in natural language (e.g., the second paragraph in the console of FIG. 8) deleted, was evaluated against the gold standard. One grammar issue in the generated code was that predicates sharing the same name are not defined consecutively, leading to execution errors on the Picat platform. To quantitatively assess textual similarity between the generated code and the gold standard, metrics such as the Levenshtein Distance, Jaro-Winkler Similarity, and Jaccard Distance were employed. FIG. 11 presents the distribution of Levenshtein Distances across some or all test cases. Given that the Levenshtein Distance measures the minimum number of single-character modifications used to transform one string into another, its values range from zero to the length of the longer string, making statistical distribution analysis more meaningful than average values. Among the 50 test cases, 20 exhibit a Levenshtein Distance of zero, signifying identity with the gold standard and absence of grammatical errors. The highest observed Levenshtein Distance was 1237 edits, with 48 cases displaying distances under 1000 edits. It can be noted that the absolute Levenshtein distance can be considered in relation to the length of the codes being compared. For example, a distance of two might be considered small when comparing long words or phrases (e.g., “international” vs. “internationale”), but significant for short words (e.g., “cat” vs. “bat”). To address that, the Jaccard Distance, which shows relative insensitivity to code length, is utilized for further analysis.

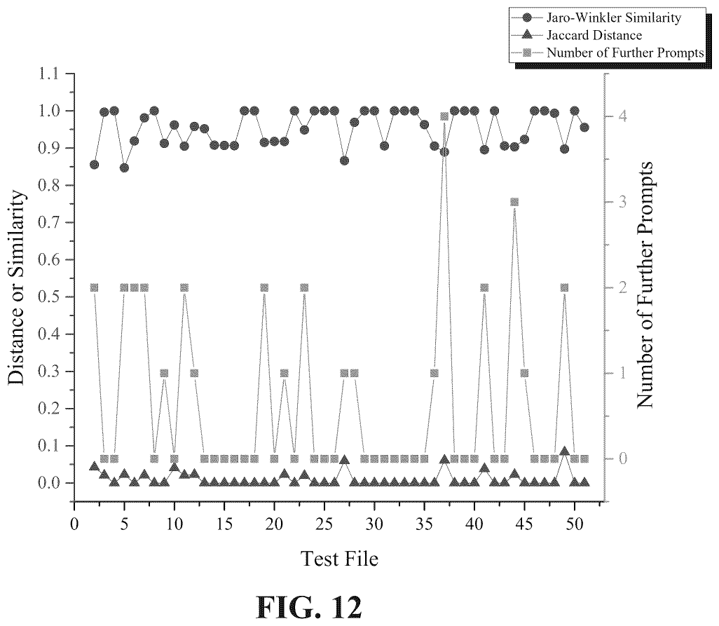

The Jaccard Distance and Jaro-Winkler Similarity for 50 test cases were computed and are depicted in FIG. 12. These two metrics inversely correlate: a higher similarity yields a Jaccard Distance approaching 0 and a Jaro-Winkler Similarity nearing 1. The mean values for the Jaccard Distance and Jaro-Winkler Similarity across some or all tests were found to be 0.0100 and 0.9535, respectively. This high level of similarity between the generated code and the gold standard demonstrates their close textual alignment, transcending the consideration of character order (noting that Jaro-Winkler Similarity accounts for character order, whereas Jaccard Distance does not). Additionally, a notable consistency exists between the Jaccard Distance, Jaro-Winkler Similarity, and the number of additional prompts used during the experiments. As illustrated in FIG. 12, instances necessitating more prompts, indicative of challenges in accurately translating specific building code requirements, correlate well with larger Jaccard Distances and lower Jaro-Winkler Similarities.

Considering these four metrics, it is apparent that despite occasional requirements for additional prompts to address translation issues, the translator succeeds in generating codes that not only reflect the building code requirements accurately but also exhibit a high degree of textual similarity to the gold standards, within a reasonable number of prompts.

To conduct a nuanced comparison between the generated code and the gold standard, metrics such as precision, recall, and the F1 score were computed at three granularity levels: logic clause level, predicate level, and predicate-element level. An illustrative example below demonstrates the calculation of precision and recall at the logic clause level.

Table 5 presents a set of generated code with the gold standard and the associated building code requirement, highlighting the discrepancies between them. In the evaluation, each logic fact or rule constitutes a logic clause. For instance, the entry in the first row, “design_area(design_area3_1).”, is treated as a single logic fact in Picat, thus considered a single evaluation unit. Similarly, the entry in the 21st row introduces a Picat logic rule, identified by “expect_yes3”, also regarded as a singular unit for comparison purposes. The analysis of this particular instance reveals that the translator's output closely aligns with the gold standard, and may prevent a minor error related to the incorrect capitalization of “NOT”. Within the Picat syntax, capitalization denotes variables, indicating a need for adjustment. In this case, the gold standard contained 21 logic clauses, with the generated code accurately reflecting 20 of these clauses, resulting in precision and recall metrics of 95.24% at the logic clause level.

TABLE 5
Example pair of generated code and gold standard in the experiment.

| Building code | | |
|---|---|---|
| requirement | Generated code | Gold standard |
| “Where the | design_area(design_area3_1). | design_area(design_area3_1). |
| design area of | design_area(design_area3_2). | design_area(design_area3_2). |
| the sprinkler | design_area(design_area3_3). | design_area(design_area3_3). |
| system consists | consists_of(design_area3_1, | consists_of(design_area3_1, |
| of a corridor | corridor3_1). | corridor3_1). |
| protected by | consists_of(design_area3_2, | consists_of(design_area3_2, |
| one row of | corridor3_2). | corridor3_2). |
| sprinklers, | consists_of(design_area3_3, | consists_of(design_area3_3, |
| the maximum | corridor3_3). | corridor3_3). |
| number of | corridor(corridor3_1). | corridor(corridor3_1). |
| sprinklers | corridor(corridor3_2). | corridor(corridor3_2). |
| required to | corridor(corridor3_3). | corridor(corridor3_3). |
| be calculated | row_of_sprinklers(row3_1). | row_of_sprinklers(row3_1). |
| is 13.” | row_of_sprinklers(row3_2). | row_of_sprinklers(row3_2). |
| | row_of_sprinklers(row3_3). | row_of_sprinklers(row3_3). |
| | protected_by(corridor3_1, row3_1). | protected_by(corridor3_1, row3_1). |
| | protected_by(corridor3_2, row3_2). | protected_by(corridor3_2, row3_2). |
| | protected_by(corridor3_3, row3_3). | protected_by(corridor3_3, row3_3). |
| | number_of_sprinklers(row3_1, 14). | number_of_sprinklers(row3_1, 14). |
| | number_of_sprinklers(row3_2, 12). | number_of_sprinklers(row3_2, 12). |
| | number_of_sprinklers(row3_3, 13). | number_of_sprinklers(row3_3, 13). |
| | max_allowed_sprinklers(13). | max_allowed_sprinklers(13). |
| | expect_yes3=> | expect_yes3=> |
| | findall((DesignArea, Corridor, | findall((DesignArea, Corridor, |
| | RowOfSprinklers, Number), | RowOfSprinklers, Number), |
| | (design_area(DesignArea), | (design_area(DesignArea), |
| | consists_of(DesignArea, Corridor), | consists_of(DesignArea, Corridor), |
| | corridor(Corridor), | corridor(Corridor), |
| | protected_by(Corridor, | protected_by(Corridor, |
| | RowOfSprinklers), | RowOfSprinklers), |
| | row_of_sprinklers(RowOfSprinklers), | row_of_sprinklers(RowOfSprinklers), |
| | number_of_sprinklers(RowOfSprinkl | number_of_sprinklers(RowOfSprinkle |
| | ers, Number), | rs, Number), |
| | max_allowed_sprinklers(Max), | max_allowed_sprinklers(Max), |
| | Number =< Max) ) = Xs3, | Number =< Max) ) = Xs3, |
| | sort(Xs3) = Xs3_sorted, | sort(Xs3) = Xs3_sorted, |
| | foreach ((DesignArea, Corridor, | foreach ((DesignArea, Corridor, |
| | RowOfSprinklers, Number) in | RowOfSprinklers, Number) in |
| | Xs3_sorted) | Xs3_sorted) |
| | writeln((the, DesignArea, with, | writeln((the, DesignArea, with, |
| | Corridor, protected, by, | Corridor, protected, by, |
| | RowOfSprinklers, with, Number, | RowOfSprinklers, with, Number, |
| | sprinklers, is, compliant, with, | sprinklers, is, compliant, with, section, |
| | section, 903,4,2,in,ibc,year2023)) | 903,4,2,in,ibc,year2023)) |
| | end. | end. |
| | expect_no3=> | expect_no3=> |
| | findall((DesignArea, Corridor, | findall((DesignArea, Corridor, |
| | RowOfSprinklers, Number), | RowOfSprinklers, Number), |
| | (design_area(DesignArea), | (design_area(DesignArea), |
| | consists_of(DesignArea, Corridor), | consists_of(DesignArea, Corridor), |
| | corridor(Corridor), | corridor(Corridor), |
| | protected_by(Corridor, | protected_by(Corridor, |
| | RowOfSprinklers), | RowOfSprinklers), |
| | row_of_sprinklers(RowOfSprinklers), | row_of_sprinklers(RowOfSprinklers), |
| | number_of_sprinklers(RowOfSprinkl | number_of_sprinklers(RowOfSprinkle |
| | ers, Number), | rs, Number), |
| | max_allowed_sprinklers(Max), | max_allowed_sprinklers(Max), |
| | Number > Max) ) = | Number > Max) ) = |
| | Xs3_non_compliant, | Xs3 non_compliant, |
| | sort(Xs3_non_compliant) = | sort(Xs3_non_compliant) = |
| | Xs3_non_compliant_sorted, | Xs3_non_compliant_sorted, |
| | foreach ((DesignArea, Corridor, | foreach ((DesignArea, Corridor, |
| | RowOfSprinklers, Number) in | RowOfSprinklers, Number) in |
| | Xs3_non_compliant_sorted) | Xs3_non_compliant_sorted) |
| | writeln((the, DesignArea, with, | writeln((the, DesignArea, with, |
| | Corridor, protected, by, | Corridor, protected, by, |
| | RowOfSprinklers, with, Number, | RowOfSprinklers, with, Number, |
| | sprinklers, is, NOT, compliant, with, | sprinklers, is, not, compliant, with, |
| | section, 903,4,2, in, ibc, year2023)) | section, 903,4,2, in, ibc, year2023)) |
| | end. | end. |

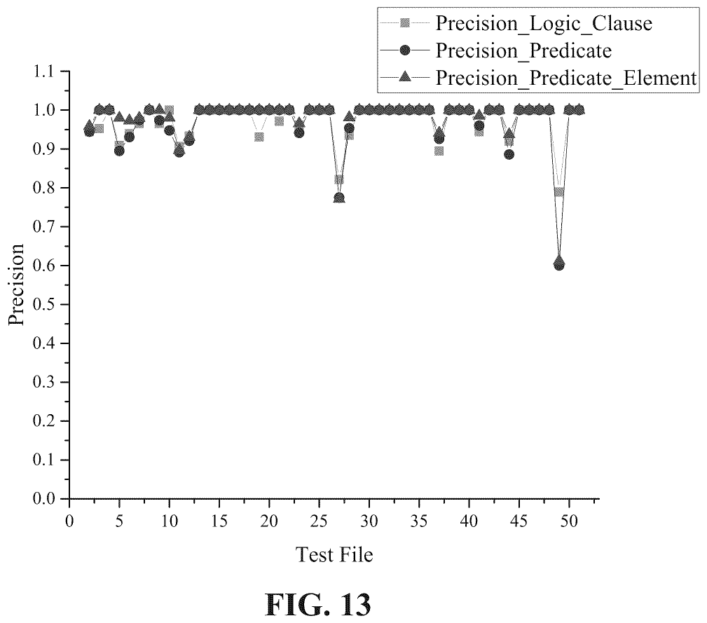

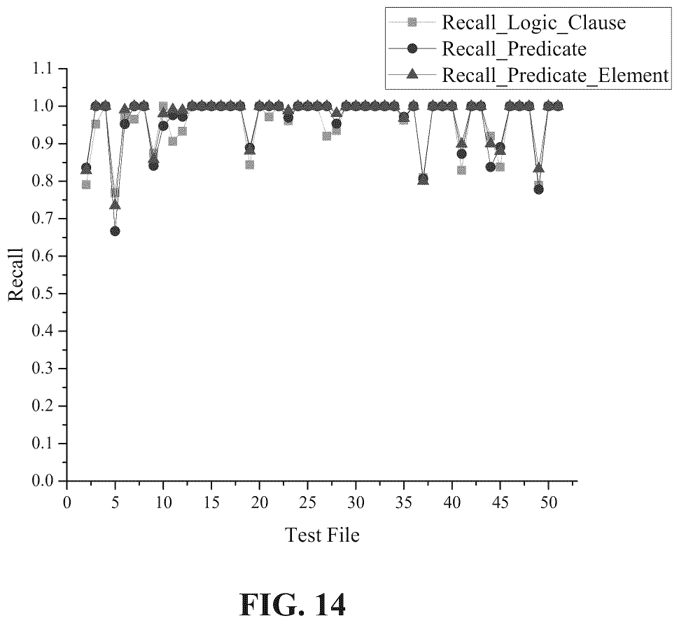

The analysis extends further by breaking down the code snippets into predicates and predicate elements to ascertain their precision and recall metrics. The outcomes of these evaluations across each experiment are depicted in FIGS. 13 and 14. Given the hierarchical structure from general to specific-logic clause, predicate, and predicate-element-it is anticipated that precision and recall metrics would exhibit an upward trend with increasing granularity. Nonetheless, anomalies observed in FIGS. 13 and 14 seem to challenge this expectation. This discrepancy arises primarily because precision and recall at the predicate and predicate-element levels are derived through automated Python scripts, whereas the assessment at the logic clause level involves manual calculation, incorporating considerations for cascading errors and overlooking repeated mistakes in certain instances. FIGS. 13 and 14 illustrate that, following initial variability, the translator's accuracy exhibits a trend towards stabilization and improvement after the 13th experiment. However, there may be some exceptions, such as in the 49th experiment, where the translator encountered difficulties in accurately defining and incorporating several concepts and relationships relevant to the building code requirements. Additional factors contributing to drops in precision and recall include the incorporation of unnecessary conditions in logic rules and inconsistent instance information. FIGS. 13 and 14 also elucidate a strong correlation between precision and recall, jointly reflecting the translator's performance across the experiments.

Table 6 presents a summary of performance of the model on building code translation task, demonstrating high accuracy, consistency, and reliability across various similarity, precision, and recall metrics. The performance of the model on the building code translation task is exemplified by its high Jaro-Winkler Similarity and low Jaccard Distance. With a Jaro-Winkler Similarity mean score of 0.9535 and a low standard deviation of 0.0481, the model produces translations that are highly similar to the gold standard. This high similarity is further reinforced by the 95% confidence interval [0.9398, 0.9672], indicating reliable performance. Simultaneously, the model exhibits minimal dissimilarity, as evidenced by the Jaccard Distance mean score of 0.0100 and a standard deviation of 0.0192. The 95% confidence interval [0.0046, 0.0155] supports the observation of low dissimilarity, highlighting the model's ability to preserve the semantic content of the original texts. Together, these metrics demonstrate the model's effectiveness in achieving high fidelity and semantic accuracy in building code translations.

The model's performance on the building code translation task can be observed using three levels of evaluation: logic clause level, predicate level, and predicate element level. Consistent with theoretical predictions, an increase in granularity leads to a gradual improvement in average precision and recall. At the logic clause level, the model achieves high precision, recall and F1 score, with mean scores of 0.9737, 0.9588 and 0.9662, respectively, indicating accurate and comprehensive capture of logic components. At the predicate level, the model maintains strong performance with mean precision of 0.9704, recall of 0.9632 and F1 score of 0.9668, showcasing its reliability in translating predicates accurately. Similarly, at the predicate element level, the highest precision, recall and F1 score are observed, with mean scores of 0.9779, 0.9701 and 0.9740, respectively, reflecting high accuracy and consistency in handling detailed elements of predicates.

TABLE 6
Evaluation metrics for building code translation experiments.

| | | Standard | Confidence |
|---|---|---|---|
| Metrics | Mean | Deviation | Intervals (95%) |
| Jaro-Winkler similarity | 0.9535 | 0.0481 | [0.9398, 0.9672] |
| Jaccard distance | 0.0100 | 0.0192 | [0.0046, 0.0155] |
| Precision (logic clause) | 0.9737 | 0.0466 | [0.9605, 0.9869] |
| Recall (logic clause) | 0.9588 | 0.0680 | [0.9395, 0.9782] |
| Precision (predicate) | 0.9704 | 0.0691 | [0.9507, 0.9900] |
| Recall (predicate) | 0.9632 | 0.0728 | [0.9425, 0.9839] |
| Precision (predicate element) | 0.9779 | 0.0649 | [0.9594, 0.9963] |
| Recall (predicate element) | 0.9701 | 0.0629 | [0.9522, 0.9880] |

When compared with conventional rule-based and machine learning-based approaches in regulatory information extraction, as shown in Table 7, the translator exhibits superior performance at the logic clause level, underscoring its efficacy in accurately translating building code requirements into logic programming constructs. Table 8 presents a detailed example comparison between a rule-based approach and the proposed method. When the two approaches are applied to the same building code requirement, the main differences in the generated code are evident: The rule-based approach generated one logic rule for checking without generating logic facts and missed the building concept “any plan dimension”. The proposed method generated both logic facts and two logic rules for checking. After two rounds of further prompts, it created three entities for testing three scenarios and two logic rules for finding compliant and noncompliant entities. The generated code can be run directly in the Picat programming environment with built-in functions. Clearly, compared to the rule-based approach, the proposed method generates more comprehensive and complete inspection rules without requiring excessive manual efforts. This demonstrates the method's potential to significantly enhance the efficiency, accuracy, and scalability of regulatory information transformation and compliance verification.

TABLE 7
Performance comparison of proposed method
with existing state-of-the-art methods.

| | Precision | Recall | F1 score |
|---|---|---|---|
| The proposed approach in this study | 97.4% | 95.9% | 96.6% |
| Rule-based approach | 96.9% | 94.4% | 95.6% |
| Machine learning-based approach | 93.1% | 92.9% | 93.0% |

TABLE 8
Example comparison of rule-based approach and LLM-based approach.

| Building | | |
|---|---|---|
| code | Generated code from | |
| requirement | rule-based approach | Generated code from the proposed approach |
| “Habitable | compliance_of_clear_{—} | entity(habitable_space1). |
| spaces, | passageway(Clear_{—} | entity(habitable_space2). |
| other than a | passageway):- | entity(habitable_space3). |
| kitchen, | habitable_spaces | quantity(length_habitable_space1). |
| shall not be | (Habitable_spaces), | quantity(width_habitable_space1). |
| less than 7 | kitchen(Kitchen), | quantity(length_habitable_space2). |
| feet in any | greater_than_or_{—} | quantity(width_habitable_space2). |
| plan | equal(Any_plan_{—} | quantity(length_habitable_space3). |
| dimension.” | dimension, quantity | quantity(width_habitable_space3). |
| | (7, feet)) | quantity(min_dimension_requirement). |
| | | has_value(length_habitable_space1, 8). |
| | | has_value(width_habitable_space1, 7). |
| | | has_value(length_habitable_space2, 6). |
| | | has_value(width_habitable_space2, 7). |
| | | has_value(length_habitable_space3, 7). |
| | | has_value(width_habitable_space3, 5). |
| | | has_value(min_dimension_requirement, 7). |
| | | has_unit(length_habitable_space1, feet). |
| | | has_unit(width_habitable_space1, feet). |
| | | has_unit(length_habitable_space2, feet). |
| | | has_unit(width_habitable_space2, feet). |
| | | has_unit(length_habitable_space3, feet). |
| | | has_unit(width_habitable_space3, feet). |
| | | has_unit(min_dimension_requirement, feet). |
| | | has_length(habitable_space1, |
| | | length_habitable_space1). |
| | | has_length(habitable_space2, |
| | | length_habitable_space2). |
| | | has_length(habitable_space3, |
| | | length_habitable_space3). |
| | | has_width(habitable_space2, width_habitable_space2). |
| | | has_width(habitable_space1, width_habitable_space1). |
| | | has_width(habitable_space3, width_habitable_space3). |
| | | dimension_compliance_check => |
| | | findall(Space, |
| | | ( |
| | | entity(Space), |
| | | has_length(Space, Length), |
| | | has_width(Space, Width), |
| | | greater_than_or_equal(Length, |
| | | min_dimension_requirement), |
| | | greater_than_or_equal(Width, |
| | | min_dimension_requirement) |
| | | ) |
| | | ) = CompliantSpaces, |
| | | sort(CompliantSpaces) = SortedCompliantSpaces, |
| | | writeln(‘Habitable spaces compliant with the |
| | | building code requirement:’), |
| | | foreach(Space in SortedCompliantSpaces) |
| | | writeln(Space) |
| | | end. |
| | | dimension_non_compliance_check => |
| | | findall(Space, |
| | | ( |
| | | entity(Space), |
| | | has_length(Space, Length), |
| | | has_width(Space, Width), |
| | | (less_than(Length, |
| | | min_dimension_requirement); less_than(Width, |
| | | min_dimension_requirement)) |
| | | ) |
| | | ) = NonCompliantSpaces, |
| | | sort(NonCompliantSpaces) = |
| | | SortedNonCompliantSpaces, |
| | | writeln(‘Habitable spaces not compliant with the |
| | | building code requirement:’), |
| | | foreach(Space in SortedNonCompliantSpaces) |
| | | writeln(Space) |
| | | end. |

The performance of the proposed framework on crash report translation was tested and analyzed to verify its adaptation. Similar to the verification of its effectiveness, the numbers of further prompts used and text similarity between generated code without natural language and gold standard were recorded and calculated. In addition, the time taken to generate the codes was recorded to assess its efficiency.

### Contemplated Embodiments

The techniques, technologies, algorithms, and advantages described herein may be implemented in a variety of practical applications, which may serve to improve systems and methods used or performed by several different individuals, companies, and/or institutions involved in building code compliance, regulatory enforcement, and software development for construction and architectural industries.

In one category of embodiments, systems and methods may be configured to function as a tool to improve the ability of municipalities and other regulatory bodies to evaluate building applications and designs for compliance with applicable codes, regulations, and standards. For example, a municipality with a building code that references state-level regulations, manufacturer specifications or instructions, and/or industry standards may deploy a platform based on the present disclosure to ensure that submitted designs meet all cross-referenced requirements. When a building application is received, the system can process the design using updated compliance scripts generated according to the techniques described herein and provide a report indicating whether the design complies with current standards. Municipal staff can use this output to approve, reject, or request modifications to applications, ensuring consistency and accuracy in enforcement.

Alternatively, or additionally, the systems and methods serving as a compliance management and update tool may output code compliance updates to a variety of downstream users, including software development companies, architects, engineers, and contractors. For instance, a software-as-a-service (SaaS) company could utilize the systems described herein to continuously monitor regulatory changes at the federal, state, and municipal levels and push updates to a network of subscribed users. These updates may include new compliance scripts, summaries of regulatory changes, and any relevant logic updates, which can be integrated directly into design and compliance-checking software. This approach ensures that software users, whether they are individual architects or large engineering firms, have access to up-to-date tools that reflect the latest standards.

In other examples, the systems and methods described herein can be utilized to improve the workflow of building software companies that integrate compliance-checking functionality into their products. Such companies might use the systems to streamline the process of updating their software when regulations change. By incorporating the described methods, these companies could automate the detection of code changes, the generation of updated scripts, and the distribution of these updates to end-users. This capability may reduce the time and manual effort used to keep their software current, thereby enhancing their product offerings and improving customer satisfaction.

In further examples, systems and methods of the present disclosure may be integrated into a regulatory testing platform that facilitates cross-jurisdictional compliance. Such a platform could enable municipalities or industry associations to test how their regulations align with or diverge from those in other jurisdictions or organizations. This may involve simulating compliance scenarios for hypothetical building designs to identify conflicts, overlaps, or gaps in the regulations. Users such as policymakers, legal advisors, or standards organizations could leverage these insights to harmonize regulations or propose updates to ensure better consistency and clarity across jurisdictions.

In further examples, systems and methods of the present disclosure may be utilized in building information modeling (BIM) platforms, which may be combined or integrated with compliance-checking modules. For instance, a BIM platform could leverage the described systems to integrate real-time compliance validation directly into its design interface. Architects and engineers working within the platform could receive immediate feedback on whether their designs comply with current regulations, complete with suggestions for adjustments to meet specific code requirements. By incorporating compliance-checking functionality into the design process, such systems could significantly reduce the risk of non-compliance and streamline the approval process with regulatory bodies. In additional embodiments, the systems and methods of the present disclosure may support workflows where builders, architects, or other end-users input specific product or component details into their designs and request updated compliance scripts based on manufacturer specifications and installation instructions. For instance, a builder preparing a design may indicate that a particular type of window, fire sprinkler system, or insulation product will be used in the construction. The system can then communicate with a SaaS provider to retrieve or generate a compliance script tailored to the specified product. The SaaS provider may access the latest manufacturer documentation or specifications, which are often referenced in building codes, and generate a script to validate that the product will be installed per the manufacturer's requirements.

This functionality may also help ensure that components are installed in a manner consistent with manufacturer warranty conditions. For example, a specific type of window may have installation instructions requiring a minimum overlap between the window frame and the wall opening, use of specified sealants, or compliance with load-bearing requirements. By leveraging the system, the end-user can obtain a script that cross-checks the design against these parameters, ensuring not only compliance with referenced building codes but also adherence to warranty-preserving practices. The SaaS company may send the script back to the builder or architect via the system interface, where it can be integrated into the compliance-checking workflow of their design software. In some embodiments, the system may also generate a report summarizing key compliance and warranty considerations, providing further value to the end-user.

These features enable a dynamic interaction between end-users and SaaS providers, ensuring that designs meet both regulatory and manufacturer-specific requirements. Additionally, this capability may enhance construction quality, reduce liability risks, and improve long-term project outcomes.

In the foregoing specification, implementations of the disclosure have been described with reference to specific example implementations thereof. It will be evident that various modifications may be made thereto without departing from the broader spirit and scope of implementations of the disclosures as set forth in the following claims. The specification and drawings are, accordingly, to be regarded in an illustrative sense rather than a restrictive sense.

What is claimed is:

1. A system for generating and distributing building code compliance scripts, comprising:
a processor;
a communications system operably connected to the processor and configured to transmit and receive information from users and building code resources via a communication network;
a memory operably connected to the processor, the memory storing software instructions that, when executed by the processor, cause the system to:
receive an indication of a target building code for translation;
determine a programming language to be used for outputs of a building code translation model, wherein the programming language comprises a logic-based syntax;
obtain a copy of the target building code, and preprocess the copy to confirm suitability for translation, including at least one of verifying completeness, identifying errors, or confirming currency of the copy of the target building code;
initialize the building code translation model to recognize the determined programming language and generate code with syntactic accuracy for the determined programming language;
generate an initial programming script that encodes at least one compliance rule of the target building code into logic statements compatible with the determined programming language;
validate the generated initial programming script by: comparing the generated initial programming script to a predefined standard programming script known to accurately encode the at least one compliance rule, or by performing functional equivalence checks by running the initial programming script on a test set of inputs and known outputs;
refine the generated initial programming script and re-validate until the script achieves a threshold level of accuracy; and
distribute the refined programming script to one or more end-users via the communications system.

2. The system of claim 1, further comprising a developer interface configured to:
present an interface to a developer to allow the developer to refine the building code translation model, including by generating training prompts or customizing example inputs and outputs; and
present summaries or comparisons of changes to building codes detected from monitored resources.

3. The system of claim 1, wherein the software instructions further cause the system to dynamically and automatically update building code compliance scripts in response to changes detected in monitored building code sources.

4. The system of claim 1, wherein the target building code comprises at least one of: a plurality of electrical standards, a plurality of fire protection standards, or a plurality of structure requirements.

5. The system of claim 1, wherein the instructions, when executed by the processor, further cause the system to:
receive a building design; and
process, using the refined programming script, the building design, to generate an indication of whether the building design complies with the target building code.

6. The system of claim 1, wherein the programming language is a logic-based programming language.

7. The system of claim 6, wherein the logic-based programming language is Prolog or Picat.

8. The system of claim 1, wherein the initial programming script is generated using a large-language model (LLM) that has been trained by:
inputting a dataset containing one or more syntax, grammar, and functional applications and corresponding logic-based representations.

9. A method for developing an automated building code for translation, the method comprising:
receiving an indication of a target building code for translation;
determining a programming language to be used for outputs of a building code translation model, wherein the programming language comprises a logic-based syntax;
obtaining a copy of the target building code, and preprocessing the copy to confirm suitability for translation, including at least one of verifying completeness, identifying errors, or confirming currency of the copy of the target building code;
initializing the building code translation model to recognize the determined programming language and generate code with syntactic accuracy for the determined programming language;
generating an initial programming script that encodes at least one compliance rule of the target building code into logic statements compatible with the determined programming language;
validating the generated initial programming script by: comparing the generated initial programming script to a predefined standard programming script known to accurately encode the at least one compliance rule, or by performing functional equivalence checks by running the initial programming script on a test set of inputs and known outputs;
refining the generated initial programming script and re-validate until the script achieves a threshold level of accuracy; and
distributing the refined programming script to one or more end-users via the communications system.

10. The method of claim 9, further comprising:
presenting an interface to a developer to allow the developer to refine the building code translation model, including by generating training prompts or customizing example inputs and outputs; and
presenting summaries or comparisons of changes to building codes detected from monitored resources.

11. The method of claim 9, further comprising: dynamically and automatically updating building code compliance scripts in response to changes detected in monitored building code sources.

12. The method of claim 9, wherein the target building code comprises at least one of: a plurality of electrical standards, a plurality of fire protection standards, a plurality of accessibility requirements, or a plurality of structure requirements.

13. The method of claim 9, further comprising:
receiving at least one of a location or a building type corresponding to a building design; and
determining if the target building code is applicable to the location or building type.

14. The method of claim 9, wherein the programming language is a logic-based programming language.

15. The method of claim 14, wherein the logic-based programming language is Prolog or Picat.

16. The method of claim 9, wherein the initial programming script is generated using a large-language model (LLM) that has been trained by:
inputting a dataset containing one or more syntax, grammar, and functional applications and corresponding logic-based representations.

17. A non-transitory machine-readable medium storing instructions, which, when executed by a processor of an electronic device, cause the processor to:
store, in a database maintained by a network of a code-updates provider, information regarding a set of relevant building codes, including current versions of the building codes and compliance scripts associated with the building codes;
monitor one or more resources associated with the set of relevant building codes, wherein the resources include online repositories, websites, or databases maintained by governmental entities, trade associations, or industry organizations;
detect a potential change to a given building code of the set of relevant building codes at a monitored resource by identifying a difference between a version of the given building code retrieved from the monitored resource and a stored version of the given building code;
characterize one or more amendments made to the potentially-changed building code version, wherein characterizing includes identifying sections that have been modified, added, or removed and ignoring merely stylistic changes that do not affect compliance;
determine whether the characterized amendments implement different compliance requirements relative to the stored version of the building code, wherein determining includes analyzing the amended sections for substantive changes in regulatory provisions;
generate, in response to a determination that different compliance requirements have been implemented, an updated compliance script based on the amendments via a trained building code compliance model, wherein the compliance script encodes changed rules or conditions corresponding to the amended building code;
validate the updated compliance script;
publish the validated updated compliance script to a set of users via a communication network, wherein publishing includes providing the compliance script for integration into compliance-checking software used by the users; and
notify the users of the amendments to the building code, wherein the notification includes a summary of the changes generated based on the characterized amendments.

18. The non-transitory machine-readable medium of claim 17, wherein to validate the updated compliance script, the instructions, when executed by the processor, cause the processor to:
compare the updated compliance script to predefined standards or templates.

19. The non-transitory machine-readable medium of claim 17, wherein to validate the updated compliance script, the instructions, when executed by the processor, cause the processor to:
execute functional tests to verify the accuracy of encoded rules.

20. The non-transitory machine-readable medium of claim 17, wherein to validate the updated compliance script, the instructions, when executed by the processor, cause the processor to:
obtain feedback or review from a user via an interface.
